(19) United States
(12) Patent Application Publication
(10) Pub. No.: US 2022/0384996 A1
(43) Pub. Date: Dec. 1, 2022

(54) METHODS AND DEVICES FOR PROTECTING A MULTI-LEVEL, MULTI-PORT CONNECTOR ASSEMBLY FROM ELECTROMAGNETIC INTERFERENCE

(71) Applicant: Molex, LLC, Lisle, IL (US)

(72) Inventors: David L. BRUNKER, Naperville, IL (US); Matthew WOLFE, Conway, AR (US); Hazelton P. AVERY, Batavia, IL (US); Scott D. SOMMERS, Naperville, IL (US); Christopher L. KAPUSCINSKI, Mount Prospect, IL (US); Bill CHEN, Maumelle, AR (US); Li ZHUANG, Long Grove, IL (US)

(73) Assignee: Molex, LLC, Lisle, IL (US)

(21) Appl. No.: 17/764,979

(22) PCT Filed: Oct. 5, 2020
(86) PCT No.: PCT/US2020/054197

§ 371 Date: Mar. 30, 2022

Related U.S. Application Data
(60) Provisional application No. 62/910,462, filed on Oct. 4, 2019.

(51) Int. Cl. H01R 13/659

(52) U.S. Cl. CPC H01R 13/659; H01R 13/6582

(57) ABSTRACT

A multi-level, multi-connector assembly that may include high-speed, low-speed and power terminals is protected from electromagnetic interference. The multi-level, multi-port connector assembly includes a bottom port connector connected with a circuit board, a top port connector positioned over the bottom port connector, and an electromagnetic shielding cage positioned over both the top port connector and the bottom port connector to provide shielding from a range of electromagnetic interference (EMI) for the top port connector and the bottom port connector. Each of the top and bottom port connectors comprise power and communication signal conductors, where the signal conductors are operable to conduct at least high-speed communication signals.

### RELATED APPLICATIONS

This application claims priority to U.S. Provisional Application 62/910,462, filed Oct. 4, 2019, which is incorporated herein by reference in its entirety.

### TECHNICAL FIELD

This disclosure relates to the field of connectors, and more specifically to connectors suitable for use in high data rate applications.

### INTRODUCTION

This section introduces aspects that may help facilitate a better understanding of the inventions. Accordingly, the statements of this section are to be read in this light and are not to be understood as admissions about what is prior art or what is not prior art.

To date, it has been challenging to produce a connector assembly that contains multiple, high speed connectors in a compact way while at the same time providing electromagnetic interference (EMI) shielding.

Accordingly, it is desirable to provide solutions to this challenge.

### SUMMARY

The inventors describe various exemplary input/output (I/O) connector assemblies. The inventive assemblies include electromagnetic interference (EMI) protection, among other things.

In one embodiment, an inventive multi-level, multi-port connector assembly may comprise: an electromagnetic shielding cage configured to protect a top port connector and to be positioned over a bottom port connector to provide shielding for at least the top and bottom port connectors from a range of electromagnetic interference (EMI), wherein at least a portion of the top port connector is positioned over the bottom port connector when the electromagnetic shielding cage is positioned over the bottom port connector. In such an embodiment, each of the top and bottom port connectors may comprise power and communication signal conductors, where the signal conductors are operable to conduct at least high-speed communication signals

In inventive connector assemblies that comprise both top and bottom port connector, the bottom port connector may comprise a surface mounted technology (SMT) connector while the top port connector may comprise a press-fit connector. Alternatively, each of the top and bottom port connectors may be configured to be connected using ball grid arrays, solder charging, press-fit, SMT or optical fiber.

In an embodiment, the cage may comprise a cover, a cage base, a top back cover, a bottom back cover, and a front end-shield, among other components, where the cover and front end-shield may comprise one or more associated apertures operable to allow air to flow through into or out of the interior of the cage. Still further, each of the one or more apertures may be configured to have a width and a depth to reduce the effects of EMI on components within an interior of the assembly, for example. Further, inventive cages may comprise an internal heat sink, first fastening clip, a top heat sink and second fastening clip, where one embodiment of the internal heat sink may have a length that is substantially the same as a full length of the cover.

In an embodiment, inventive front end-shields may comprise a plurality of conductive, deformable elements formed around part, or substantially all, of a perimeter of the end shield, the elements comprising part of a ground conductor, and inventive first fastening clips may comprise one or more deformable elements operable to apply a force on the internal heat sink to make contact with components within the cage.

The top port connector or bottom port connector may comprise part of a bypass connector, for example.

In addition to the connection techniques described above, inventive assemblies may be configured such that a top port connector comprises high-speed communication signal terminals configured to be connected to a circuit board using cables and low-speed communication signal terminals or power terminals configured to be connected to a circuit board using cables, and a bottom port connector comprises high-speed communication signal terminals configured to be connected directly to the board and low-speed communication signal terminals or power terminals configured to be connected directly to the board.

Alternatively, an inventive connector assembly may be configured such that a top port connector comprises high-speed communication signal terminals configured to be connected to a circuit board using cables and low-speed communication signal terminals or power terminals configured to be connected directly to the board, and a bottom port connector comprises high-speed communication signal terminals configured to be connected to the board using cables and low-speed communication signal terminals or power terminals configured to be connected directly to the board.

Another alternative, connector assembly may be configured such that a top port connector comprises high-speed communication signal terminals configured to be connected to a circuit board using cables and low-speed communication signal terminals or power terminals configured to be connected directly to the board, and a bottom port connector comprises high-speed communication signal terminals configured to be connected directly to the board and low-speed communication signal terminals or power terminals configured to be connected directly to the board.

Still another alternative, connector assembly may be configured such that a bottom port connector comprises low-speed communication signal terminals or power terminals configured to be connected to a circuit board using cables.

In addition to inventive connector assemblies, the inventors provide inventive methods for shielding a multi-level, multi-port connector assembly from EMI. One such method may comprise: mounting a bottom port connector to a circuit board; protecting a top port connector and the mounted bottom port connector with an electromagnetic shielding cage to shield at least the top and bottom port connectors from a range of electromagnetic interference (EMI). Such a method may further comprise conducting at least high-speed communication signals and power from the top and bottom connectors.

In additional embodiments, mounting the bottom port connector may comprise connecting the bottom port connector using surface mounted technology (SMT), connecting the top port connector to the circuit board may comprise using a press-fit connection.

Other connection techniques may also be used. For example, a top port connector and bottom port connector may be connected to a circuit board using SMT, a press-fit connection, ball grid arrays, solder charging, or optical fiber, for example.

As previously noted, in exemplary methods the cage may comprise a cover, cage base, a top back cover, a bottom back cover, and an EMI front end-shield.

The inventive methods may yet further comprise additional features, such as (1) allowing air to flow through into, or out of, the interior of the cage using one or more apertures in the cage, where each of the one or more apertures may be configured to have a width and a depth to reduce the effects of EMI on components within an interior of a cage, (2) forming a ground conductor from a plurality of conductive, deformable elements formed around part, or substantially all, of a perimeter of a front end shield.

Similarly, as noted previously, in each of the inventive methods, a top port connector or bottom port connector may comprise at least part of bypass connector.

The inventive top and bottom port connectors may comprise a combination of high-speed, low-speed and power terminals and may be connected to a circuit board in a number of ways.

For example, in one inventive method a top port connector comprises high-speed communication signal terminals and low-speed communication signal terminals or power terminals. Such a method may comprise connecting both sets of terminals to a circuit board using cables.

In another inventive method a bottom port connector comprises high-speed communication signal terminals and low-speed communication signal terminals or power terminals. Such a method may comprise connecting both set of terminals directly to a circuit board.

A further inventive method comprises a top port connector, where the top port connector comprises high-speed communication signal terminals and low-speed communication signal terminals or power terminals. Such a method may comprise, connecting the high-speed communication signal terminals to a circuit board using cables and connecting the low speed communication signal terminals or power terminals directly to the circuit board.

Still another inventive method comprises a bottom port connector, where the bottom port connector comprises high-speed communication signal terminals and low-speed communication signal terminals or power terminals. Such a method may further comprise connecting the high-speed communication signal terminals to a circuit board using cables and connecting the low speed communication signal terminals or power terminals directly to the circuit board.

Two additional inventive methods comprise (i) a top port connector that comprises high-speed communication signal terminals configured to be connected to the circuit board using cables and low-speed communication signal terminals or power terminals configured to be connected directly to a board, and a bottom port connector that comprises high-speed communication signal terminals configured to be connected directly to the board and low-speed communication signal terminals or power terminals configured to be connected directly to the board, and (ii) a bottom port connector that comprises low-speed communication signal terminals or power terminals. Such a latter method may comprise connecting the terminals to a circuit board using cables.

### BRIEF DESCRIPTION OF THE DRAWINGS

The present invention is illustrated by way of example and is not limited by the accompanying figures in which like reference numerals indicate similar elements and in which:

FIG. 1 depicts a perspective view of an exemplary, inventive connector assembly according to an embodiment of the invention.

FIGS. 2A and 2B depict a front view and rear view, respectively, of an assembly according to an embodiment of the invention.

FIG. 3 depicts an ‘exploded” view of exemplary components that may be used to construct an exemplary shielded cage according to an embodiment of the invention.

FIGS. 4 and 5 depict exemplary apertures according to embodiments of the invention.

FIG. 6 depicts a perspective, internal view of an exemplary connector assembly in accordance with an embodiment of the present invention.

FIG. 7 depicts a partially exploded view of a top port connector of an exemplary connector assembly in accordance with an embodiment of the present invention.

FIGS. 8A and 8B depict side views of exemplar connectors in accordance with embodiments of the present invention.

FIG. 9 depicts an illustrative view of the interior of an exemplary assembly in accordance with an embodiment of the present invention.

FIGS. 10 and 11 depict an inventive assembly with high-speed communication signal terminals and low-speed or power terminals of a top port connector connected to a circuit board in accordance with embodiments of the present invention.

FIGS. 12 and 13 depict an inventive assembly in accordance with embodiments of the present invention.

FIGS. 14 to 17 depict an inventive assembly comprising modular sections in accordance with embodiments of the present invention.

Specific embodiments of the present invention are disclosed below with reference to various figures and sketches. Both the description and the illustrations have been drafted with the intent to enhance understanding. For example, the dimensions of some of the elements in the figures may be exaggerated relative to other elements, and well-known elements that are beneficial or even necessary to a commercially successful implementation may not be depicted so that a less obstructed and a more clear presentation of embodiments may be achieved.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

The terms “a” or “an”, as used herein, are defined as one or more than one. The term “plurality”, as used herein, is defined as two or more than two. The term “another”, as used herein, is defined as at least a second or more.

Unless otherwise indicated herein, the use of relational terms, if any, such as “first” and “second”, “top” and “bottom”, and the like are used solely to distinguish one entity or action from another entity or action without necessarily requiring or implying any actual such relationship, order or importance between such entities or actions.

The terms “including” and/or “having”, as used herein, are defined as comprising (i.e., open language). The term “coupled”, as used herein, is defined as connected, although not necessarily directly, and not necessarily mechanically. The use of “or” or “and/or” herein is defined to be inclusive (A, B or C means any one or any two or all three letters) and not exclusive (unless explicitly indicated to be exclusive); thus, the use of “and/or” in some instances is not to be interpreted to imply that the use of “or” somewhere else means that use of “or” is exclusive. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

As used herein the phrases “high-speed” and “high data rate” are meant to be synonymous unless the context or knowledge of one skilled in the art indicates otherwise. Similarly, the phrases “low-speed” and “low data rate” are meant to be synonymous unless the context or knowledge of one skilled in the art indicates otherwise.

As used herein the phrase “operable to” means “functions to” unless the context or knowledge of one skilled in the art indicates otherwise.

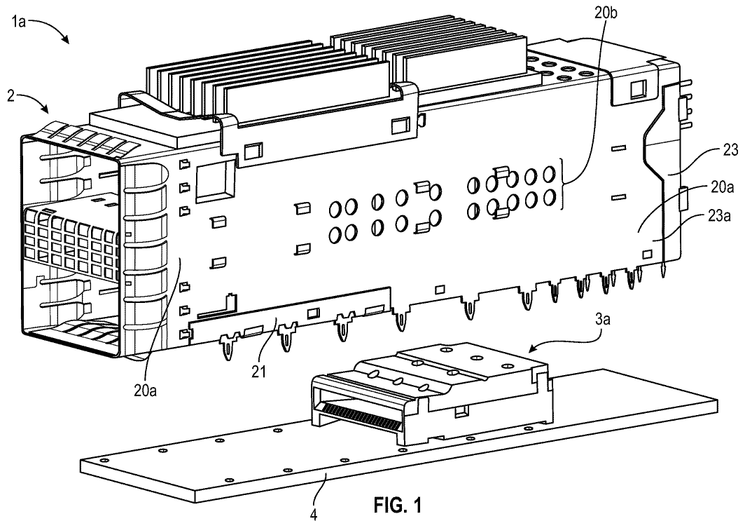

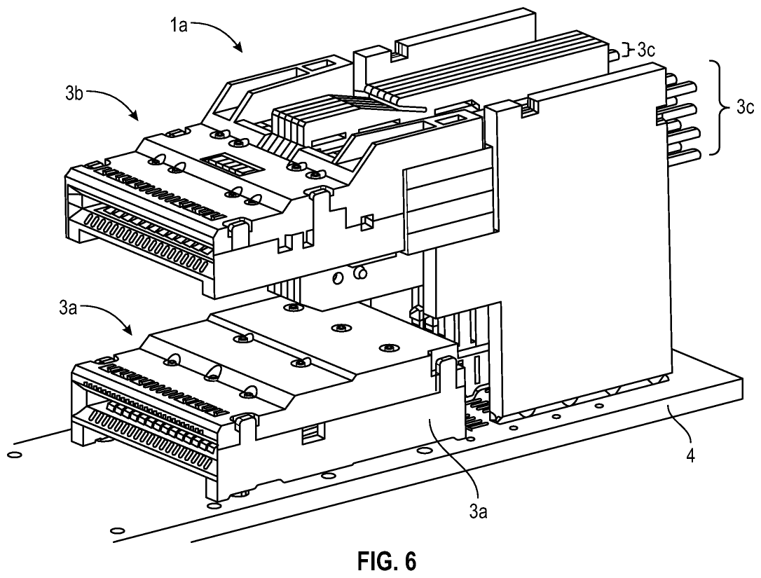

Referring now to FIG. 1, there is depicted a perspective view of an exemplary, inventive multi-level, multi-port connector assembly 1a. As shown, the assembly 1a may comprise an electromagnetic shielding cage 2 that is configured to protect a top port connector 3b (hidden from view, but see FIG. 6) and a bottom port connector 3a, and a circuit board 4 according to one embodiment of the invention.

In more detail, in the embodiment depicted in FIG. 1a, the cage 2 is positioned over the bottom port connector 3a and provides shielding for at least the top and bottom port connectors (and other components within the cage) from a range of electromagnetic interference (EMI), wherein at least a portion of the top port connector 3b (again, not shown) is positioned over the bottom port connector 3a, where again, the electromagnetic shielding cage 2 is positioned over the bottom port connector 3a.

The connectors 3a, 3b may comprise an input/output (I/O) connector, such as those used for optical small form-factor pluggable applications or double density optical small form-factor pluggable applications, for example. As configured, the assembly may be referred to as a multi-port, multi-level, EMI shielded connector.

In more detail, embodiments, each of the connectors 3a, 3b may be configured to conduct electrical or optical signals. In the latter case, each connector may comprise optical-to-electrical (O/E) or electrical-to-optical (E/O) conversion circuitry. In additional embodiments, each connector 3a, 3b may include active electrical devices, such as amplifiers and retiming circuitry.

In many instances, the O/E, E/O conversion circuitry, active devices and retiming circuitry may generate a substantial amount of heat during operation Thus, as described further herein, each connector may comprise one or more heat sinks.

Continuing, each connector 3a, 3b may comprise one or more separate power and communication signal conductors that form a part of separate power and communication signal paths (i.e., typically, the ports are not electrically connected to one another). In embodiments, at least exemplary high-speed communication signals up to, and exceeding, 112 gigabits per second (Gbps) may be transported by the signal conductors of the connectors 3a, 3b of the assembly 1a. In alternative embodiments, communication signals up to 160 Gbps may be transported by conductors of the connectors 3a, 3b of the assembly 1a.

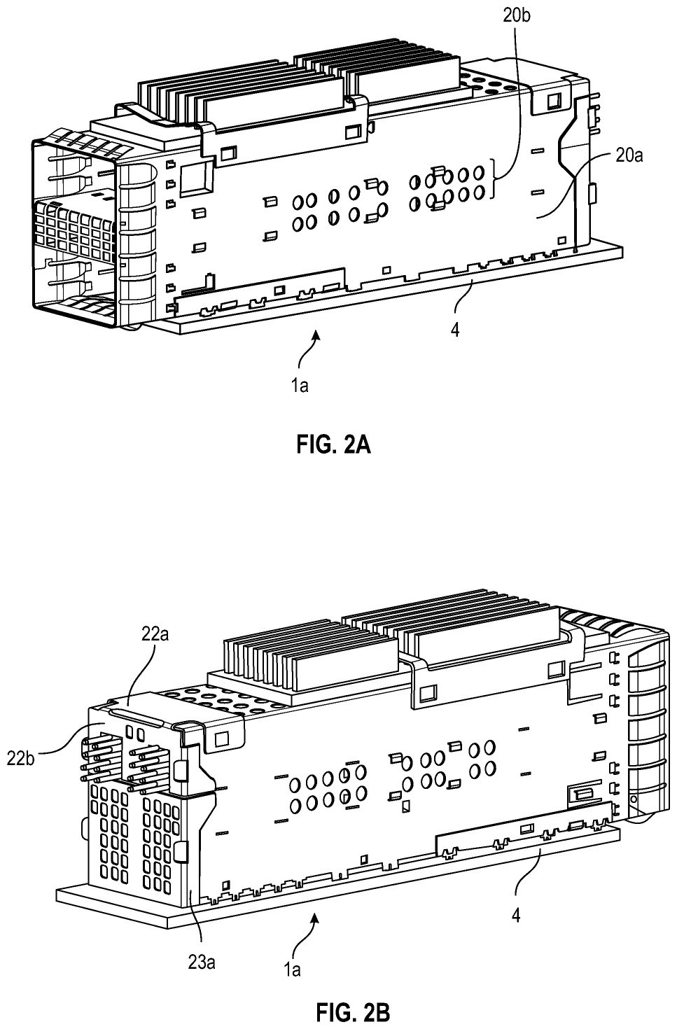

In one embodiment the bottom port connector 3a may be a surface mounted technology (SMT) connector, for example, that may first be mounted to the board 4 using a soldering process, for example Thereafter, the top port connector 3b (again, not shown) and cage 2 may be press-fitted to the board 4 such that the top port connector 3b and cage 2 are positioned over the bottom port connector 3a as shown in FIGS. 2A and 2B to form a multi-level, multi-port connector assembly, where FIG. 2A shows a front view and FIG. 2B a rear view of the assembly 1a. So positioned, the cage 2 is operable to shield both the top and bottom port connectors from a range of electromagnetic interference (EMI) (e.g., nominally covering 10 MHz to 50 GHz). In alternative embodiments, the bottom port connector 3a and cage 2/attached top port connector 3b may be connected to the board 4 using a ball grid array, solder charge, press-fit, SMT, an optical fiber technique or a combination of such techniques, for example. As a result both the top port connector and the mounted bottom port connector 3a, 3b are protected with the electromagnetic shielding cage 2 in order to shield at least the top and bottom port connectors 3a, 3b from a range of electromagnetic interference (EMI).

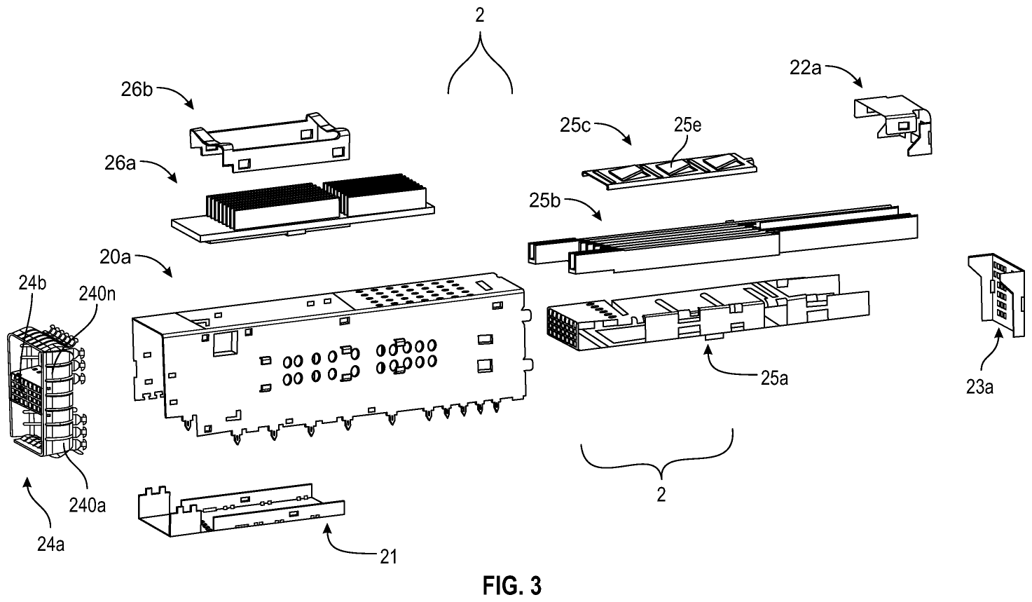

Referring now to FIG. 3, there is shown an ‘exploded” view of exemplary components that may be used to construct the exemplary shielded cage 2. As depicted, cage 2 may comprise a three-sided, conductive cover 20a (e.g., a top and two sides) with a cage base 21, a top back cover 22a, a bottom back cover 23a, and an EMI front end-shield 24a. Each of these components 20a, 21, 22a, 23a and 24a may be operable to shield components that they respectively cover, such as the top and bottom connectors, from EMI. In an embodiment, the components 20a, 21, 22a, 23a and 24a may be composed of a sufficiently conductive metal or conductive plated plastic, for example, though these are just two of the types of conductive materials that may be used.

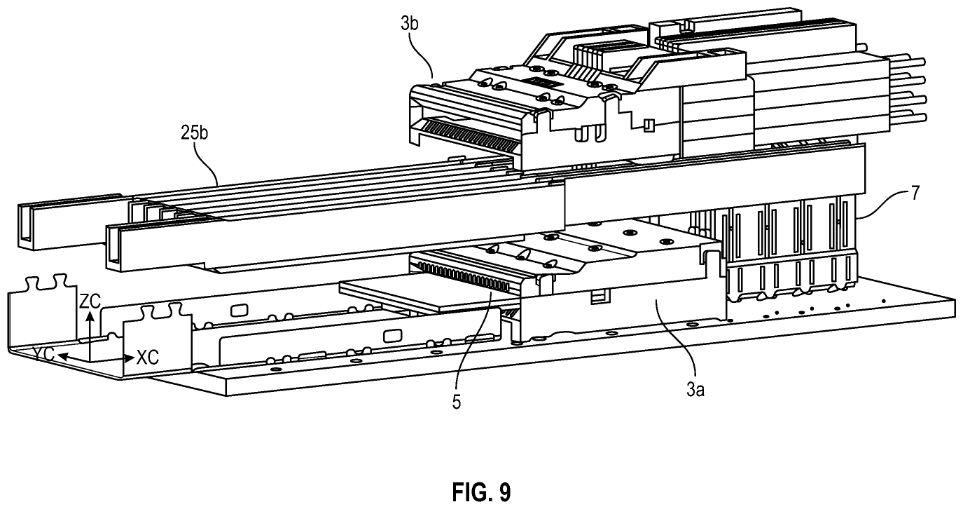

The front end-shield 24a may comprise one or more associated openings, apertures or vents 24b (collectively “apertures”) that are operable to allow air to flow through into, and/or out of, the interior of the cage 2 in order to reduce the temperature of components enclosed by the cage 2, such as the top port connector 3b and any component connected to the connector 3b. Further, the front end-shield 24a may further comprise a plurality of conductive, deformable “fingers” or elements 240a to n (collectively “elements”, where “n” indicates the last element) that may be formed around part, or substantially all, of the perimeter of the shield 24a. In an embodiment, another device (e.g., paddle card, see component 5 in FIG. 9) having corresponding, opposed deformable elements (not shown) may be pushed onto and positioned over elements 240a to n such that the other device can be said to be “plugged into” the assembly 1a. The opposing forces of the two opposing sets of deformable elements secure the other device to the assembly 1a. Yet further, in an embodiment, because the elements 240a to n are conductive an electrical ground path may be established.

Continuing, the cage 2 may further comprise a cage midsection 25a that may include an internal heat sink 25b and first fastening clip 25c, and a top heat sink 26a and second fastening clip 26b, the latter two components configured to be positioned on cover 20a. While FIG. 3 depicts cage 2 as including all of the just described components, it should be understood that other connector assembly embodiments are envisioned that include only a subset of such components. Yet further, additional embodiments may include: (i) additional components that are not shown in FIG. 3; (2) fewer components (i.e., a subset of the components shown in FIG. 3); and/or (iii) a subset of the components shown in FIG. 3 with additional components that are not shown in FIG. 3, for example.

In more detail, the first fastening clip 25c may comprise one or more deformable elements 25e that are operable to apply a force on the internal heat sink 25b which is within cage midsection 25a. As a result of the force the heat sink 25b makes contact with components within the cage 2, such as a plug module inserted into the bottom port connector. Turning to the second fastening clip 26b, in an embodiment the clip 26b may be operable to apply a force to the top heat sink 26a so that the heat sink 26a makes contact with components enclosed by, and within, the cage 2, such as a plug module inserted into the top port connector, O/E and/or E/O conversion circuitry, active devices and/or retiming circuitry, for example.

In embodiments of the invention, the inventive assembly 1a may comprise additional components other than the front end-shield 24a that are operable to reduce the temperature of interior components of the assembly 1a. For example, each of the cover 20a (see FIG. 1), top back cover 22a, bottom back cover 23a (see FIG. 2B), and cage midsection 25a (see FIG. 3) may comprise one or more correspondingly associated apertures 20b, 22b, 23b and 25d, respectively, that are operable to allow air to flow through to the interior of the cage 2 in order to reduce the temperature of components enclosed by the cage 2.

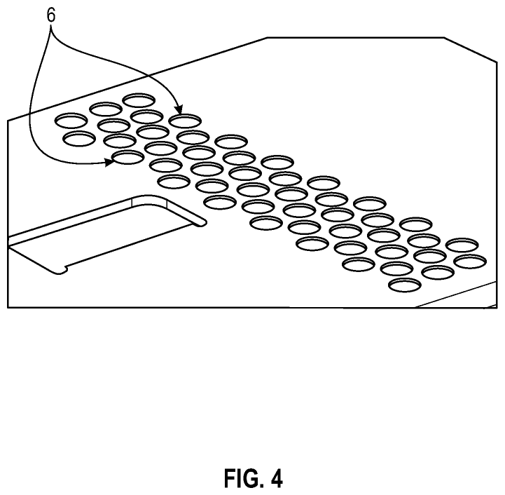

Depending on the embodiment, one or more of each of the above described apertures may be shaped as a hexagon, such as the apertures 6 depicted in FIG. 4. Alternatively, one or more of each of the above described apertures may be shaped as a circle to name just two of the many different types of aperture shapes that may be utilized and still allow the apertures to function to reduce the temperature of components of an inventive assembly. Further, a given set of associated apertures may include a subset of hexagonal shaped apertures and a subset of circular shaped apertures, for example. In embodiments, a surface area and/or structure of a component of an inventive assembly (e.g., components 20a, 22a, 23a, 25a) may allow inclusion of more hexagon-shaped apertures than circular-shaped apertures due to the dimensions of the component and aperture (i.e., more hexagon-shaped apertures may be formed in a component than circular-shaped apertures).

Further, each aperture, such as apertures 20b for example, may be configured to have a width to reduce the effects of EMI on components within an interior of the assembly la depending on the frequency or frequencies sought to be attenuated and may be configured to have an extruded depth to reduce the effects of EMI on interior components depending on the amount of attenuation (e.g., in dB) desired. For example, the smaller the width of the aperture the higher the upper cutoff frequency that can be attenuated while a deeper in extruded depth aperture can attenuate more of a given signal at a given frequency (i.e., reduce the decibel level of a signal). In an embodiment, an aperture used as a part of an inventive assembly may have a width and extruded depth (i.e., may be sized) that corresponds to an amount of attenuation desired.

Further, in embodiments a given sized aperture within a group of apertures may be repeated aperiodically to avoid aperture to aperture enhancement or “gain” at a given frequency or band of frequencies.

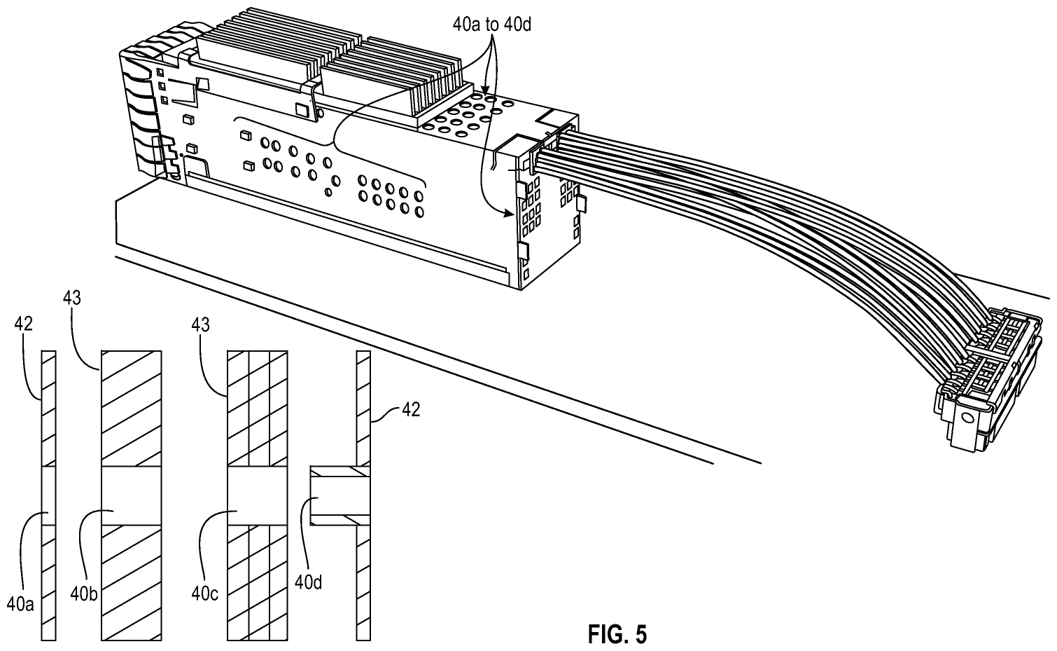

Exemplary apertures are depicted in FIG. 5 where apertures 40a, 40b, 40c and 40d each have the same width and, therefore, would attenuate signals at substantially the same range of frequencies. However, because exemplary apertures 40b, 40c and 40d have a greater extruded depth than aperture 40a such apertures would attenuate a given signal at a given frequency more than aperture 40a, for example (i.e., apertures 40b, 40c and 40d reduce the decibel level of a signal more than aperture 40a).

As also shown in FIG. 5, the thickness of the cover 20a may be set to achieve a desirable EMI, attenuation level. For example, a thin thickness 42 composed of a given material may attenuate unwanted frequencies less than a thicker thickness 43 of the same given material. Still further, the cover 20a may be comprised of multiple layers 44a-n of the same, or different, attenuating materials (e.g., layers can be composed of metallic material while others can be composed of other conductive materials, such as plated plastics).

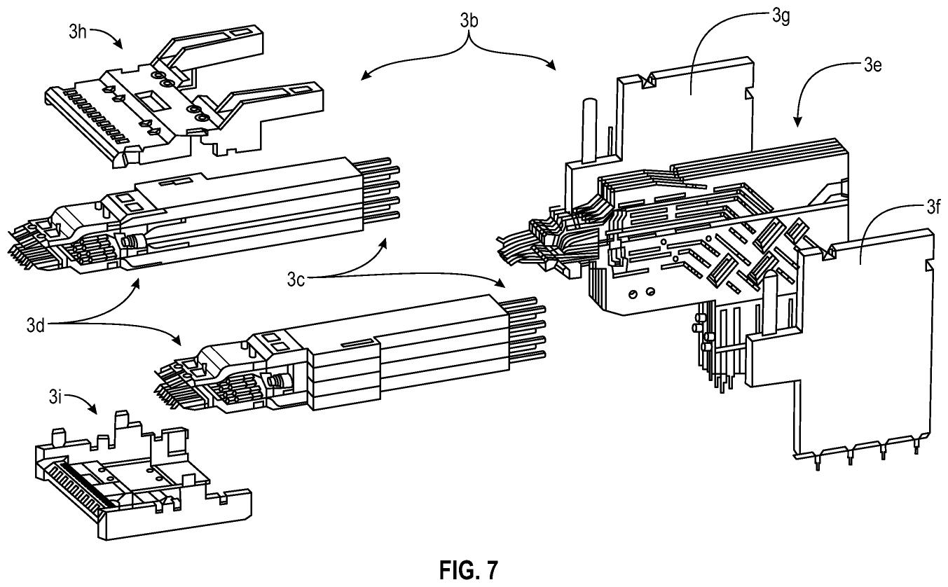

FIG. 6 depicts a perspective, internal view of connector assembly 1a with a top port connector 3b and a bottom port connector 3a mounted on circuit board 4 in accordance with an embodiment of the present invention. Referring now to FIG. 7 there is depicted a partially exploded view of the top port connector 3b. As shown the connector 3b may comprise a bypass connector with cables 3c (e.g., twinax, differential cables), where each discrete cable may be operable to convey high speed signaling (e.g., 112 Gbps, up to 160 Gbps in and out of connector 3b. In this embodiment, top port connector 3b may further comprise high-speed wafers 3d, centrally positioned low-speed/power wafers 3e, ground wafers 3f, 3g, and top and bottom housings 3h, 3i, respectively. By “bypass connector” is meant a connector that is connected to a circuit board at one position and passes signals via connected cabling to/from another position on the circuit board that is substantially next to an application-specific, integrated circuit (ASIC), for example (or other component), that is also connected to the same board, thereby bypassing intermediate electrical traces of the circuit board in order to reduce any signal loss, cross-talk or other adverse effects related to such traces for example

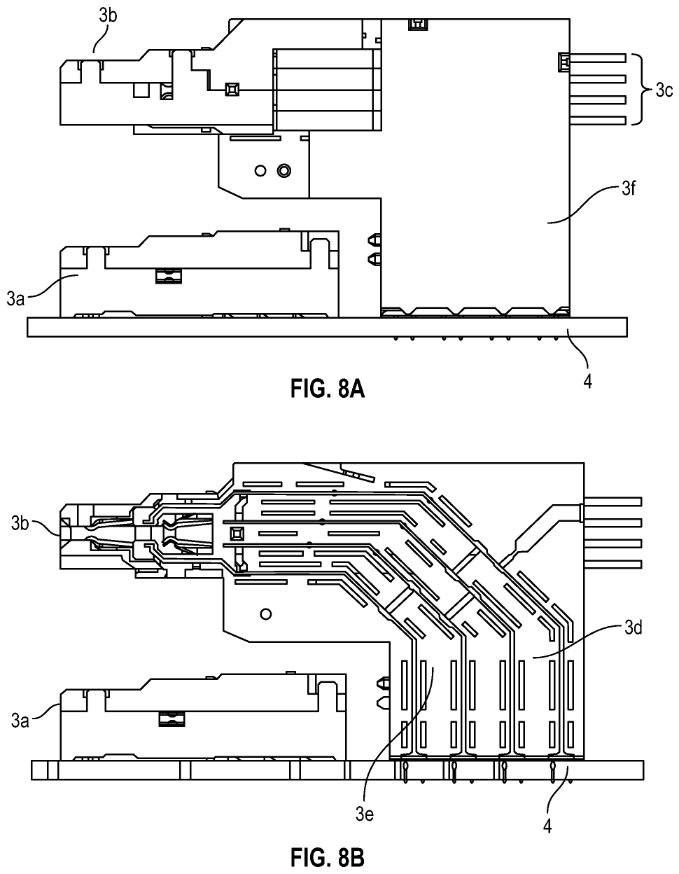

FIGS. 8A and 8B depict side views of the connectors 3a, 3b. As shown, the view of connector 3b in FIG. 8b is a partial cross-sectional view in accordance with an embodiment of the present invention. As depicted, conductors within wafers 3e that may be transporting low-speed or power signals may be connected to circuit board 4 while conductors within wafers 3d that may be transporting high-speed signals may be connected to cables 3c (e.g., twinax cables).

Referring now to FIG. 9 there is depicted an illustrative view of the interior of the assembly 1a with the cover 20a removed. In an embodiment, the internal heat sink 25b may extend substantially the same as the full length of the cover 20a. Also shown is an overmold 7 covering the ground wafer 3f (not visible). In an embodiment the overmold 7 may be composed of a plastic, for example.

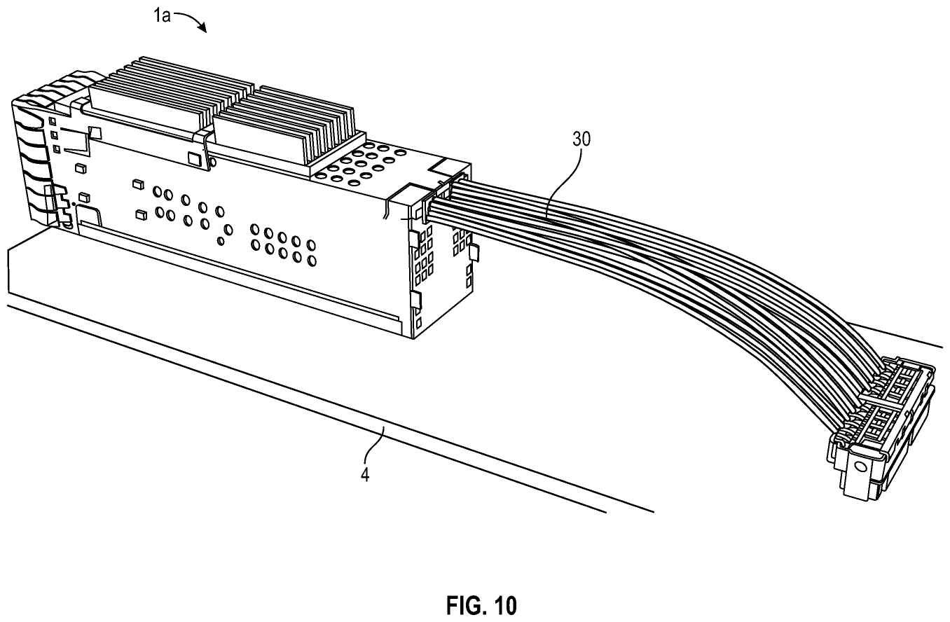

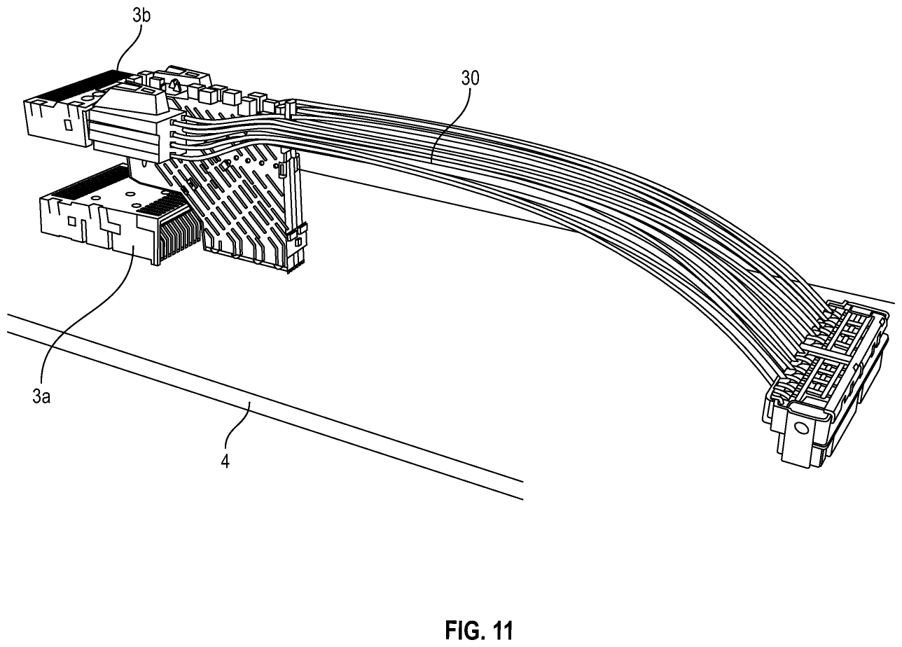

Referring now to FIGS. 10 and 11 the inventive assembly 1a is illustrated with its high-speed communication signal terminals (e.g., 112 Gbps) and low-speed (e.g., below 10 Gbps) or power terminals (e.g., 1.6 amps) of the top port connector 3b may be configured to be connected to the board 4 using respective cables 30.

It should be understood that these speeds and power levels are merely exemplary. For example, in an alternative embodiment a connector may comprise low speed power conductors with associated and assigned ground contacts to electrically isolate each conductor (i.e., conductor contact) in order to increase the speed (i.e., data rate) above 10 Gbps, for example. Further, in alternative embodiments, a connector 3a, 3b may include multiple, parallel power terminal contacts to achieve power levels above 1.6 amps, for example.

In FIG. 11, the cover 20a of the assembly 1a has been removed to allow the reader to see the connectors 3a, 3b. As shown, the high-speed communication signal terminals may be positioned on the left and right side of the top port connector 3b while the low-speed or power terminals may be positioned centrally between the high-speed communication signal terminals (not shown), for example. In this embodiment, the high-speed communication signal terminals and low-speed/power terminals of the bottom port connector 3a may be configured to be connected directly to the board 4 (i.e., no cables are used).

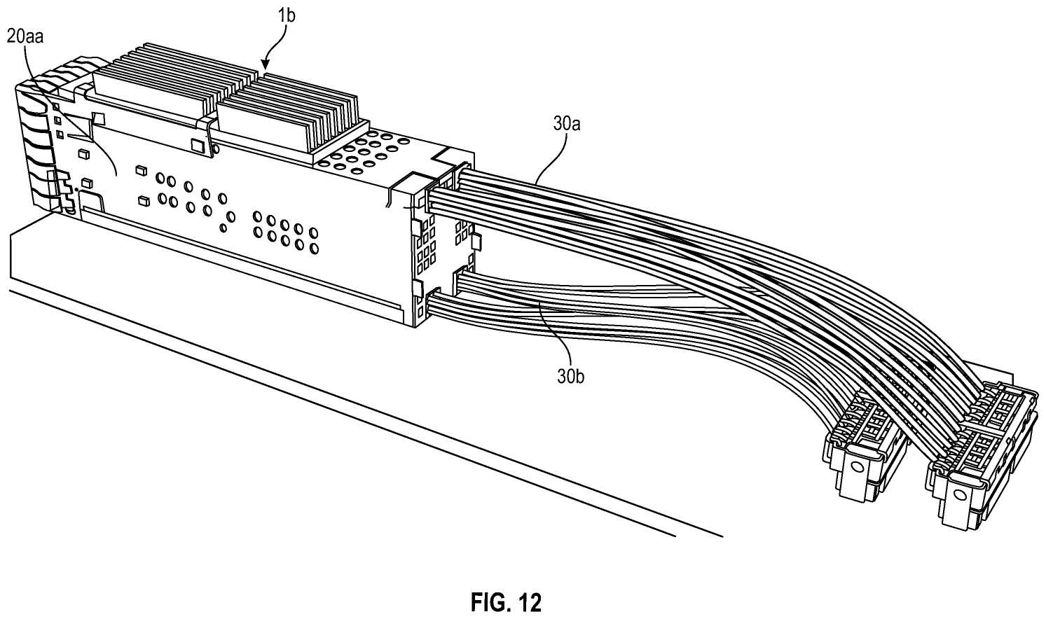

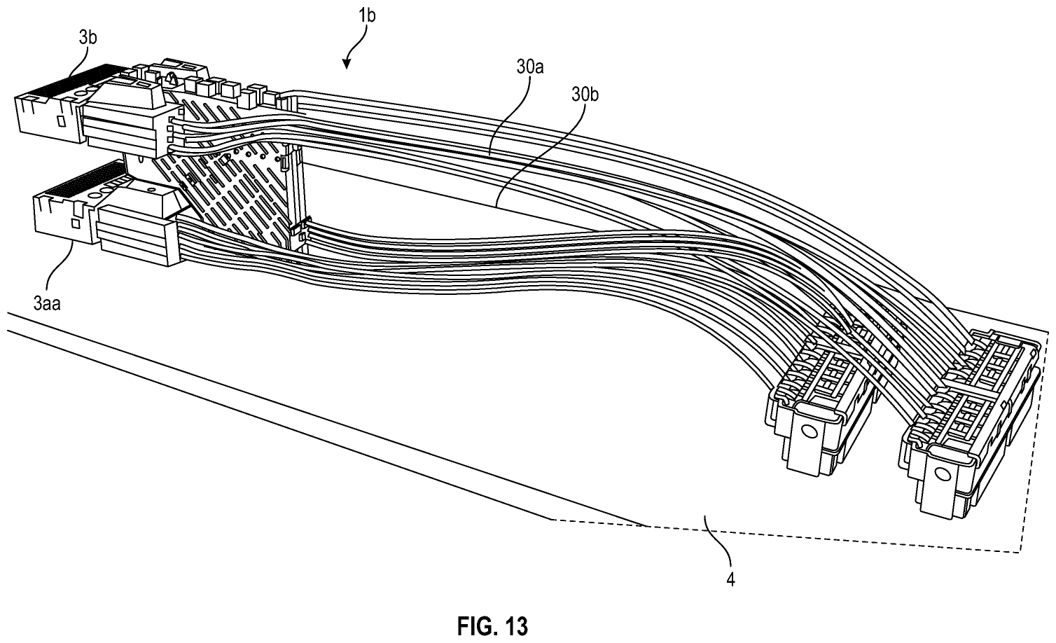

Referring now to FIGS. 12 and 13 the inventive assembly lb is illustrated with the high-speed communication signal terminals of the top port connector 3b and a bottom port connector 3aa configured to be connected to the board 4 using respective cables 30a, 30b, respectively. In FIG. 13, the cover 20aa of the assembly lb has been removed to allow the reader to see the connectors 3aa, 3b. As shown in FIG. 13, the high-speed communication signal terminals of connectors 3aa, 3b may be positioned on the left and right side of the respective connectors. In this embodiment, the centrally positioned low-speed/power terminals (not shown) of both the top and bottom port connectors 3aa, 3b may be configured to be connected directly to the board 4 (i.e., no cables are used).

In the embodiments depicted in FIGS. 1 to 13 the low-speed/power terminals of the top port connectors are depicted as being configured to be directly connected to the board 4. In other embodiments, such terminals may be configured to be connected to the board 4 using respective cables (e.g., discrete wires, twinax, or other components that can conduct low-speed signals).

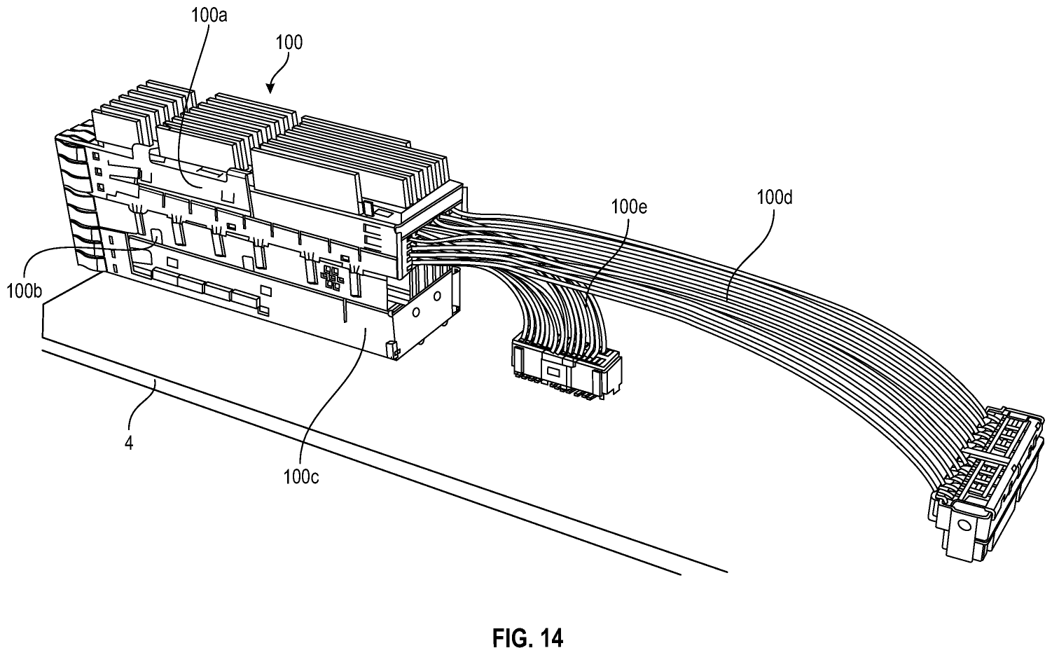

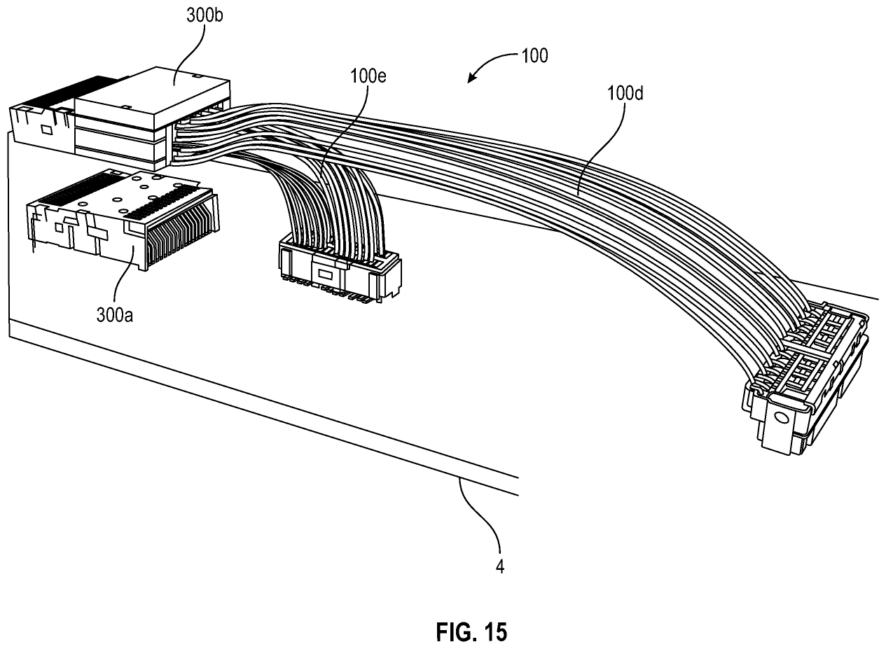

For example, referring now to FIG. 14, in this embodiment an inventive assembly 100 may comprise modular sections 100a, 100b and 100c and may be constructed by positioning section 100b on top of section 100c, and section 100a on top of section 100b, for example. The assembly 100 may comprise a bottom port 300a and top port connector 300b as shown in FIG. 15. In FIG. 15, the covers of the modular sections have been removed to allow the reader to see the connectors 300a, b. In an embodiment, both the high-speed communication signal terminals and low-speed/power terminals of the top port connector 300b may be configured to be connected to the board 4 using respective cables, 100d, 100e, respectively. As shown in FIG. 15, the high-speed communication signal terminals may be positioned on the left and right side of the top port connector 300b while the low-speed or power terminals may be positioned centrally between the high-speed communication signal terminals, for example.

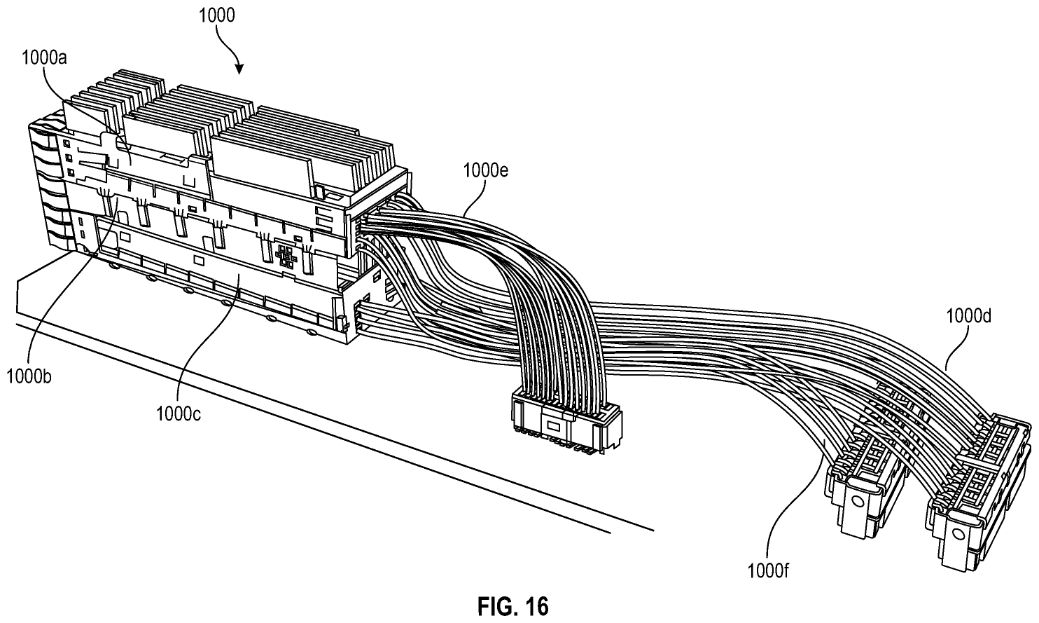

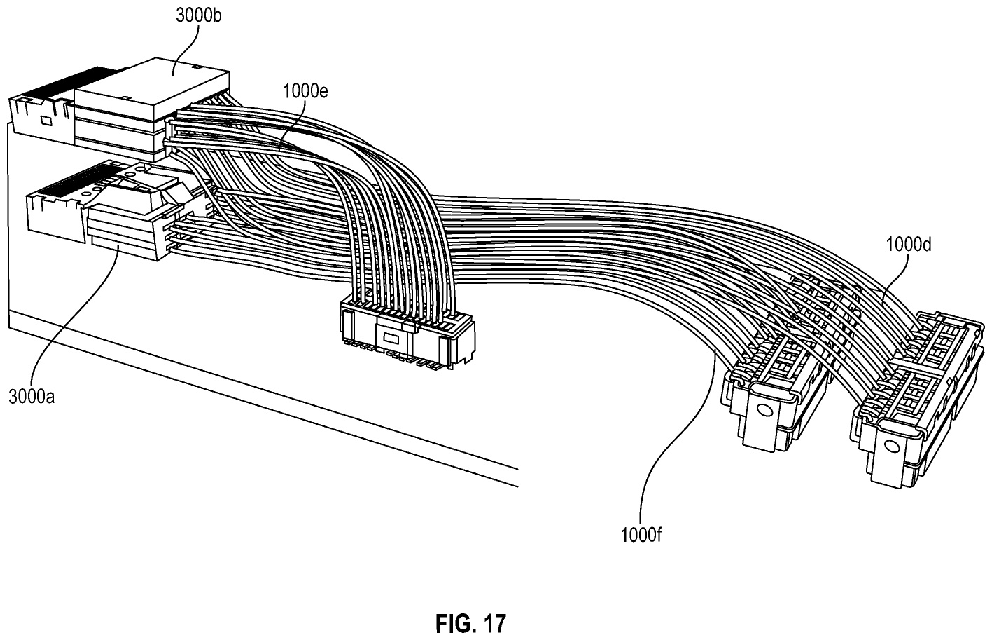

Referring now to FIG. 16, similar to assembly 100, there is depicted an inventive assembly 1000 that may comprise modular sections 1000a, 1000b and 1000c that may be constructed by positioning section 1000b on top of section 1000a, and section 1000c on top of section 1000b, for example. The assembly 1000 may comprise a bottom port 3000a and top port connector 3000b as shown in FIG. 17. In FIG. 17, the covers of the modular sections have been removed to allow the reader to see the connectors 3000a, b. In an embodiment, high-speed communication signal terminals and low-speed/power terminals of the top port connector 3000b may be configured to be connected to the board 4 using respective cables, 1000d, 1000e, respectively. As shown in FIG. 17, the high-speed communication signal terminals may be positioned on the left and right side of the top port connector 3000b while the low-speed or power terminals may be positioned centrally between the high-speed communication signal terminals, for example. In addition, in this embodiment high-speed communication signal terminals of the bottom port connector 3000a may be configured to be connected to the board 4 using cables 1000f as well. It should be understood that the bottom port connectors described herein may be bypass connectors. Further, though in the figures the low-speed or power terminals of the bottom port connector are depicted as being configured to be directly connected to the board 4, in alternative embodiments such terminals may be configured to be connected to the board 4 using appropriate low-speed components described previously herein. In yet an additional embodiment, an inventive assembly may comprise one or more of the features described previously herein, and in addition, may comprise a top port connector that comprises high-speed communication signal terminals configured to be connected to a circuit board using cables and low-speed communication signal terminals or power terminals configured to be connected directly to the board. Further, such an assembly may comprise a bottom port connector that comprises high-speed communication signal terminals configured to be connected directly to the board and low-speed communication signal terminals or power terminals configured to be connected directly to the board.

It should be understood that the cables used to connect terminals of a top or bottom port to another device such as the board 4, need not be twinax cables. Other types of cables, such as may be used. Yet further, optical cables may be used instead of coaxial or copper cables. In the case that optical cables are used, an inventive assembly may incorporate optical-to-electrical conversion circuity (and vice-versa) as described previously herein.

The claim language included below is incorporated herein by reference in expanded form, that is, hierarchically from broadest to narrowest, with each possible combination indicated by the multiple dependent claim references described as a unique standalone embodiment.

While benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

1. A multi-level, multi-port connector assembly comprising:
an electromagnetic shielding cage positioned over a bottom port connector to provide shielding from a range of electromagnetic interference (EMI) for at least a top port connector and a bottom port connector, wherein at least a portion of the top port connector is positioned over the bottom port connector when the electromagnetic shielding cage is positioned over the bottom port connector.

2. The connector assembly as in claim 1 wherein each of the top and bottom port connectors comprise power and communication signal conductors, where the signal conductors are operable to conduct at least high-speed communication signals.

3. The connector assembly as in claim 1 wherein the bottom port connector comprises a surface mounted technology (SMT) connector.

4. The connector assembly as in claim 1 wherein the top port connector comprises a press-fit connector.

5. The connector assembly as in claim 1 wherein the top and bottom port connectors are configured to be connected to a circuit board using ball grid arrays, solder charging, press-fit, SMT or optical fiber.

6. The connector assembly as in claim 1 wherein the electromagnetic shielding cage comprises a cover, a cage base, a top back cover, a bottom back cover, and a front end-shield.

7. The connector assembly as in claim 6 wherein the cover and front end-shield comprise one or more associated apertures operable to allow air to flow through into or out of the interior of the cage.

8. The connector assembly as in claim 7 wherein each of the one or more apertures is configured to have a width and a depth to reduce the effects of EMI on components within an interior of the assembly.

9. The connector assembly as in claim 6 wherein the front end-shield comprises a plurality of conductive, deformable elements formed around part, or substantially all, of a perimeter of the end shield, the elements comprising part of a ground conductor.

10. The connector assembly as in claim 6 wherein the cage further comprises an internal heat sink, first fastening clip, a top heat sink and second fastening clip.

11-13. (canceled)

14. The connector assembly as in claim 1 wherein the top port connector comprises high-speed communication signal terminals configured to be connected to a circuit board using cables and low-speed communication signal terminals or power terminals configured to be connected to the circuit board using cables and the bottom port connector comprises high-speed communication signal terminals configured to be connected directly to the circuit board and low-speed communication signal terminals or power terminals configured to be connected directly to the board.

15. The connector assembly as in claim 1 wherein the top port connector comprises high-speed communication signal terminals configured to be connected to a circuit board using cables and low-speed communication signal terminals or power terminals configured to be connected directly to the circuit board, and wherein the bottom port connector comprises high-speed communication signal terminals configured to be connected to the circuit board using cables and low-speed communication signal terminals or power terminals configured to be connected directly to the circuit board.

16-33. (canceled)

34. A multi-level, multi-port connector assembly comprising:
a bottom port connector connected with a circuit board;
a top port connector positioned over the bottom port connector; and
an electromagnetic shielding cage positioned over both the top port connector and the bottom port connector to provide shielding from a range of electromagnetic interference (EMI) for the top port connector and the bottom port connector,
wherein each of the top and bottom port connectors comprise power and communication signal conductors, where the signal conductors are operable to conduct at least high-speed communication signals.

35. The connector assembly of claim 34, wherein the electromagnetic shielding cage includes a cover, a cage base, a top back cover, a bottom back cover, and a front end-shield.

36. The connector assembly of claim 35, wherein the cover and front end-shield form one or more associated apertures operable to allow air to flow through into or out of the interior of the cage, wherein each of the one or more apertures have a width and a depth to reduce the effects of EMI on components within the connector assembly.

37. The connector assembly of claim 36, wherein a given sized aperture within a group of apertures may be repeated aperiodically to avoid aperture to aperture enhancement at a Liven frequency or a band of frequencies.

38. The connector assembly of claim 37, wherein the cover and front end-shield comprise one or more associated apertures operable to allow air to flow through into or out of the interior of the cage.

39. The connector assembly as in claim 35, wherein the front end-shield comprises a plurality of conductive, deformable elements formed around part, or substantially all, of a perimeter of the end shield, the elements comprising part of a ground conductor.

40. The connector assembly as in claim 35, wherein the cage further comprises an internal heat sink, first fastening clip, a top heat sink and second fastening clip.

41. The connector assembly as in claim 34 wherein the top port connector comprises high-speed communication signal terminals connected to the circuit board using cables and low-speed communication signal terminals or power terminals connected to the circuit board using cables and the bottom port connector comprises high-speed communication signal terminals connected directly to the circuit board and low-speed communication signal terminals or power terminals connected directly to the circuit board.
